(19) United States
(12) Patent Application Publication
(10) Pub. No.: US 2011/0067024 A1
(43) Pub. Date: Mar. 17, 2011

(54) System and method of downloading add-on elements to extend software functions

(75) Inventors: Chaucer Chiu, Taipei (TW); Xiao Hui Shao, Shanghai (CN)

(73) Assignee: INVENTEC CORPORATION, Taipei (TW)

(21) Appl. No.: 12/591,618

(22) Filed: Nov. 25, 2009

(30) Foreign Application Priority Data
Sep. 15, 2009 (TW) 098131083

(51) Int. Cl. G06F 9/445; G06Q 10/00; G06Q 30/00; G06Q 20/00; G06Q 50/00; G06F 21/24

(52) U.S. Cl. 717/178; 705/318; 726/30; 705/26.35

(57) ABSTRACT

This specification discloses a system and method of downloading add-on elements to extend software functions. After the server generates the payment file for the add-on elements selected by the client according to the selected payment method, the payment file is transmitted to the client. After the client successfully verifies the rights limitation data in the payment file, the add-on elements are loaded for the user to customize the software. This also achieves the effects of combining with programs and data of some third-party manufacturers.

### BACKGROUND OF THE INVENTION

1. Field of Invention

The invention relates to a system of expanding software functions and the method thereof. In particular, the invention pertains to a system of expanding software function by downloading add-on elements and the method thereof.

2. Related Art

With the rise of network trades, the E-commerce era has started. Many manufacturers actively adopt the business to customer (B2C) model. Therefore, as the B2C model becomes more mature, people can conveniently buy various kinds of merchandises via the Internet, regardless of their sizes, shapes, etc. Buyers only need to purchase the merchandise on an E-commerce trade platform, and make the payment according to the agreement. Companies will also ship the products to the buyers according to the agreed shipping method.

When a buyer purchases merchandise, he must want to maximize the efficiency. One always picks the ones that are needed the most. After that, the buyer starts to select products with additional functions. The goal is to reduce the expenses. Therefore, customized products have become more popular. The same reasoning also applies to consumers on software.

Whether the purchase is done via a retailer's store or an E-commerce trading platform, the application software currently obtained usually integrates many sub-functions in order to suit most people. The applications are not customized according to user's needs. Therefore, the user can only select an application that satisfies all his needs but also some other sub-functions, or he can select one that does not contain additional sub-functions but cannot fully satisfy his needs.

It is understandable that most users would opt for the former, i.e., selecting software that satisfies all the user's needs as well as additional sub-functions. However, in such software, some sub-functions may not be further supported due to the techniques and theory foundations involved therein. As a result, the software developer may resort to a capable third party and buy the processing engine or database for the sub-functions. The acquired processing engine or database is then integrated with the original software. This inevitably increases the developing cost and thus the price of the software. In this case, the user may not be willing to pay for something that he does not desperately need. Instead, such users start to look for software that does not have additional sub-functions and does not satisfy all their needs.

In summary, the prior art has the problem that software cannot be customized according to user's needs. It is necessary to provide a convenient solution.

### SUMMARY OF THE INVENTION

In view of the foregoing, the invention provides a system and method that download add-on elements to extend software functions.

The disclosed system of downloading add-on elements to extend software functions includes: a transmitting module for connecting to a server; an input module, which selects an add-on element and a payment method on the server via the transmitting module, downloads the payment file using the transmitting module, the payment file including the add-on element and the rights limitation data of the corresponding payment method; and an add-on element loading module, which verifies the rights limitation data after opening the payment file and, after successfully verifying the rights limitation data, loads the add-on element. After using the input module to select the add-on element and the payment method, the transmitting module downloads the payment file including the add-on element. After the add-on element loading module successfully verifies the rights limitation data in the payment file, it loads the add-on element to the system. This solves the problem in the prior art.

The disclosed method of downloading add-on elements to extend software functions involves a server and a client. The server includes: a first storage module for storing at least one add-on element; a rights defining module for generating rights limitation data according to a payment method; a rights setting module for writing rights limitation data into the add-on element, thereby generating a payment file; and a first transmitting module for transmitting payment file. The client includes: a second transmitting module for connecting to the server and downloading the payment file; an input module for selecting an add-on element and a payment method via the second transmitting module; an add-on element loading module for verifying the rights limitation data after opening the payment file and loading the add-on element after successfully verifying the rights limitation data. After the client selects the payment method and the add-on element via the input module, the rights setting module of the server generates a payment file containing the add-on element according to the payment method. The payment file is transmitted via the first transmitting module to the second transmitting module of the client. The add-on element loading module of the client loads the add-on element after successfully verifying the rights limitation file in the payment file.

The disclosed method of downloading add-on elements to extend software functions includes the steps of: connecting a client to the server; selecting an add-on element and a payment method on the server from the client; generating rights limitation data by the server according to the payment method; adding the rights limitation data to the add-on element to render a payment file by the server; transmitting the payment file from the server to the client; opening the payment file on the client; verifying the rights limitation data at the client; loading the add-on element after the client successfully verifies the rights limitation data. It is featured in that the server generates a payment file including the add-on element selected by the client according to the client's payment method. The payment file is sent to the client. After the client successfully verifies the rights limitation data in the payment file, the add-on element is loaded. This solves the problem in the prior art.

As described above, the disclosed system and method differ from the prior art in that after the server generates the payment file including the add-on element selected by the client according to the payment method opted by the client, the payment file is transmitted to the client. After the client successfully verifies the rights limitation data in the payment file, the add-on element is loaded. This achieves the goal of conveniently incorporating programs and data provided by a third party.

### BRIEF DESCRIPTION OF THE DRAWINGS

The invention will become more fully understood from the detailed description given herein below illustration only, and thus is not limitative of the present invention, and wherein:

FIG. 1 shows the structure of the disclosed system of downloading add-on elements to extend software functions.

FIG. 2A is a schematic view showing the internal element of the server according to the disclosed system of downloading add-on elements to extend software functions.

FIG. 2B is a schematic view showing the internal element of the client according to the disclosed system of downloading add-on elements to extend software functions.

FIG. 3A is a flowchart of the disclosed method of downloading add-on elements to extend software functions.

FIG. 3B is a flowchart of the steps of verifying the rights limitation data at the client according to the invention.

FIG. 4 is a schematic view of the configuration file in an embodiment of the invention.

### DETAILED DESCRIPTION OF THE INVENTION

The present invention will be apparent from the following detailed description, which proceeds with reference to the accompanying drawings, wherein the same references relate to the same elements.

The add-on element mentioned herein is an item that enables the main program (application software) to provide additional, specific function or reads addition data for specific processing. They include, but are not limited to, plug-ins (or add-ins and add-ons), extension data, and the combination thereof.

A plug-in program is normally developed by a third party, hoping to expand the functions of the main program. It could also be a product of extracting partial functions away from the main program, in the hope of compactifying the main program code.

The biggest difference between a plug-in program and a main program that can run independently is that the plug-in program cannot execute independently. A plug-in program has to be loaded by a main program in order to function. Moreover, the plug-in program does not alter the main program after it is loaded. Generally speaking, the main program offers a public application software interface for plug-in programs to use the resources thereof. The plug-in program interacts with the main program via the public application software interface.

The extension data include data files that record specific messages or a database (e.g., dictionary database). However, the invention is not limited to these examples.

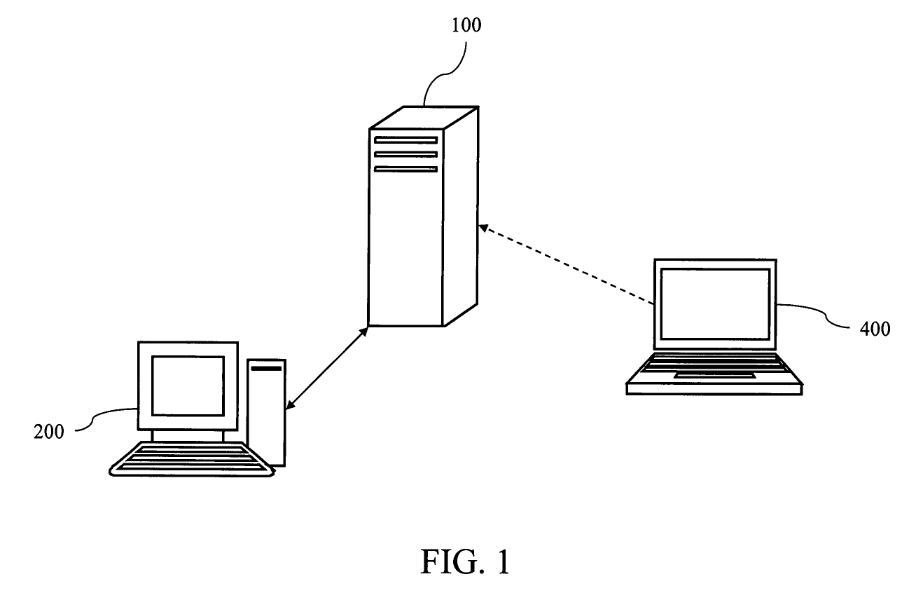

Please refer to FIG. 1 for the structure of the disclosed system of downloading add-on elements to extend software functions. As shown in the drawing, the server 100 provides add-on elements for a client 200 to download and use. In addition, the add-on elements provided by the server 100 to the client 200 can be uploaded by a third party client 400 or by the main program developer. The invention does not impose any restriction on this issue.

Since the add-on elements are to be downloaded and used by the client 200, the invention employs the Digital Rights Management (DRM) technique to protect the add-on elements from being pirated.

The DRM is a technique used to control the privilege of using a protected object. The DRM can protect digital contents (e.g., software, music, movies, and electronic documents) and hardware that processes digital contents. The DRM technique usually adds additional restrictions to the protected object, thereby controlling the usage thereof. The DRM restrictions include, but are not limited to, “the digital contents can only be displayed on designated software or hardware”, “the digital contents can only be displayed on a specific date or between specific dates”, “the digital contents can only be played a certain number of times”, “the digital contents can only be transmitted to designated hardware a certain number of times”, “the digital contents can only be duplicated for a certain number of times”, and various combination thereof.

The rights owner of the digital contents (publisher or maker of the digital contents) can define the rights and restrictions. After the settings, the restrictions are encrypted into the digital contents using the DRM technique. As a result, only a specific computer and using specific application software can one play or duplicate the digital contents. In that case, even if the digital contents are released, other computers or playing devices cannot display the contents. This method can effectively prevent the digital contents from being pirated.

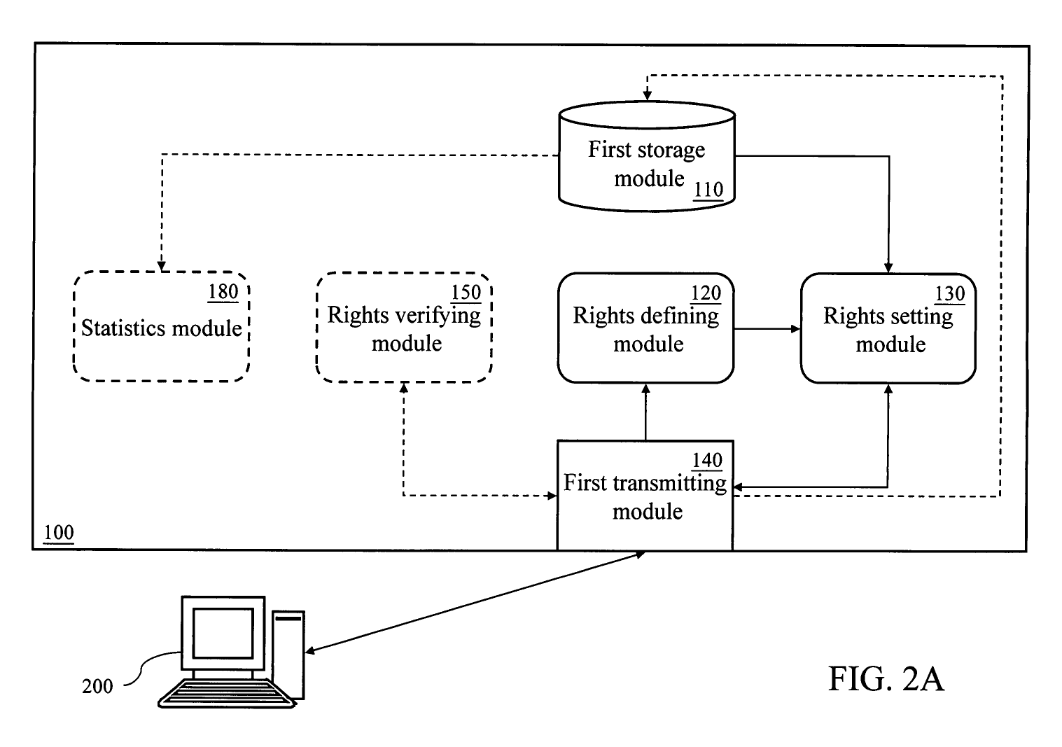

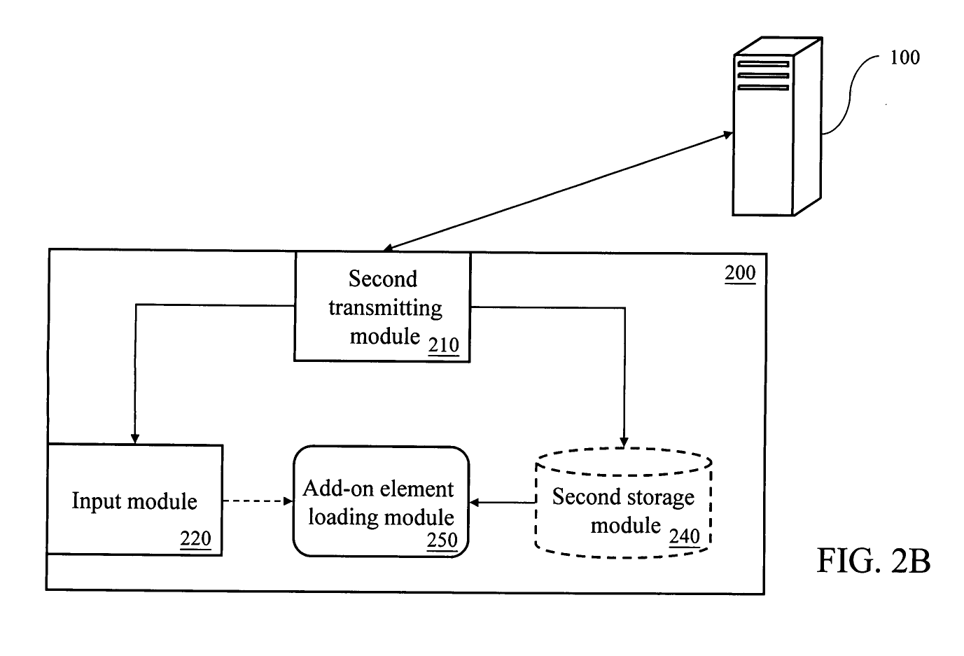

Please refer to FIG. 2A for the internal elements of the server according to the disclosed system of downloading add-on elements to extend software functions. As shown in the drawing, the server 100 contains a first storage module 110, a rights defining module 120, a rights setting module 130, and a first transmitting module 140.

The first storage module 110 stores add-on elements.

The rights defining module 120 generates rights limitation data according to the payment method selected by the user. The payment methods in the invention include, but are not limited to, “pay-per-use” which only allows using the add-on element once and “pay-per-time” which allows unlimited use of the add-on element within a specific time period. The rights limitation data generated by the rights defining module 120 correspond to the add-on element selected by the user. The rights limitation data include the user's verification data and the time that is allowed to use the add-on element. Usually it is a digital certificate. But the invention is not limited to this example.

The rights setting module 130 encrypts the rights limitation data generated by the rights defining module 120 into the corresponding add-on element using the DRM technique, rendering the payment file. That is, the payment file generated by the rights setting module 130 includes the add-on element and the corresponding rights limitation data, so that the add-on element downloaded by the user is protected by the DRM technique.

The first transmitting module 140 receives the selection signals of the user's selecting the add-on element and the payment method. The received selection signals are provided to the rights setting module 130 and the rights defining module 120, so that the rights defining module 120 knows the selected add-on element and payment method. The first transmitting module 140 also sends the payment file generated by the rights setting module 130 to the client 200.

The first transmitting module 140 further receives the rights verification data transmitted from the client 200 and corresponding to the add-on element. The verification result generated by the rights verifying module 150 is sent back to the client 200.

The server 100 further includes a rights verifying module 150, which checks the rights verification data received by the first transmitting module 140. After checking the rights verifying data using the DRM technique, a corresponding verifying result is produced corresponding to the add-on element. In fact, if the verification fails, the rights verifying module 150 can produce no verification result at all.

Please refer to FIG. 2B for the internal elements of the client 200 according to the disclosed system of downloading add-on elements to extend software functions. It shows how the user operates on the client 200. As shown in the drawing, the client 200 includes a second transmitting module 210, an input module 220, and an add-on element loading module 250.

The second transmitting module 210 connects to the server 100, and transmits the selection signals of the user's selecting the add-on element and payment method to the server 100. After transmitting the selection signals, it downloads the payment file containing the selected add-on element and the corresponding rights limitation data from the server 100.

The second transmitting module 210 also sends the rights verification data corresponding to the user selected add-on element to the server 100 for verification. It also receives the verification result returned by the server 100.

The input module 220 enables the user to select the add-on element and the payment method after the second transmitting module 210 connects to the server 100. After the user selects the add-on element and the payment method, it generates the selection signals of the selected add-on element and the selected payment method.

The input module 220 can further enable the user to enter the usage duration of the add-on element after he selects the “pay-per-time” option. The usage duration includes a time period or simply a deadline. The invention is not limited to these examples.

The add-on element loading module 250 loads the add-on element contained in the payment file. Since the add-on element may be a plug-in program or extension data, there are different add-on loading modules 250 for different types of add-on elements. For example, when the add-on element is a plug-in program, the add-on loading module is a loader so that the plug-in program is executed at the client 200 after being loaded. If the add-on element is a set of extension data, the corresponding add-on loading module 250 is a file reading program so that the extension data are used by the main program at the client 200 after being read. For example, suppose the add-on element is a plug-in program of human voices. The add-on element loading module 250 loads the plug-in program of human voices for it to be executed at the client 200 and produce voices. When the add-on element is a set of dictionary data, the add-on element loading module 250 loads the dictionary data and lets the main program (translation software) running on the client 200 read its data.

In fact, the client 200 can further have a second storage module 240 for storing the payment files downloaded by the second transmitting module 210. They are then provided to the add-on element loading module 250.

Besides, since the add-on element enables the main program to provide additional, specific functions or to read additional data for specific processing, the main program may be able to execute multiple plug-in programs with the same functions or several extension data with similar contents. Therefore, when the user executes a specific function on the main program, such as human voices, the main program may have two different plug-in programs of human voices. In this case, the add-on loading module 250 selects a plug-in program of human voices according to a default value or user setting. Suppose the add-on element is an English dictionary database (extension data). When the main program searches for the English explanation of a particular word and finds two different English dictionary databases, the add-on loading module 250 selects to load one of them or both of them.

In fact, when the add-on element loading module 250 reads the add-on element in the payment file, the user may need to verify the rights limitation data using the DRM technique before loading the add-on element. Or it may need to generate rights verification data corresponding to the add-on element according to the rights limitation data. The rights verification data are then transmitted by the second transmitting module 210 to the server 100 for verification.

After the add-on element loading module 250 successfully verifies the rights limitation data in the payment file or the second transmitting module 210 receives a successful verification from the server 100 for the rights verification data, the add-on element in the payment file is loaded into memory. If the add-on element loading module 250 cannot successfully verify the rights limitation data in the payment file or the second transmitting module 210 receives a failed verification from the server 100 for the rights verification data, the add-on element loading module 250 does not load the add-on element. If the add-on element loading module 250 transmits the rights verification data to the server 100 via the second transmitting module 210 and the second transmitting module 210 does not receive the verification result within a predetermined time, the add-on element loading module 250 determines that the verification is failed and does not load the add-on element.

Moreover, the disclosed server 100 further includes a statistics module 180, which gathers such information as client information, the payment method, and the number of download times and/or the download time of the add-on element. It also records the client information received by the first transmitting module 140. The client information includes the IP address and computer name of the client 200. It may even include the name of the plug-in program used by the user or the provider name. The invention is not limited to these examples.

In order to the statistics module 180 to conveniently gather the IP address, the payment method, the number of download times, and the download time of the client 200, the first storage module 110 of the server 100 records such information. When the first transmitting module 140 receives the rights verification data transmitted from the second transmission module 210, the data are transmitted by the second transmission module 210 to the client for storage.

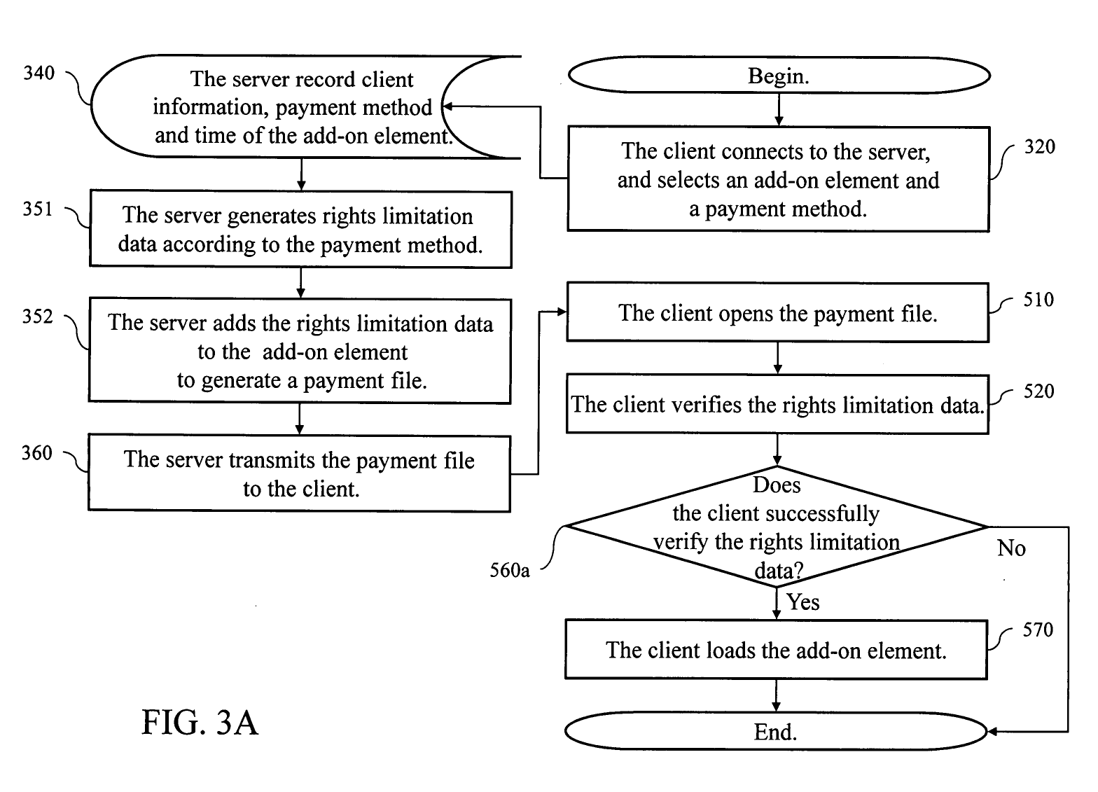

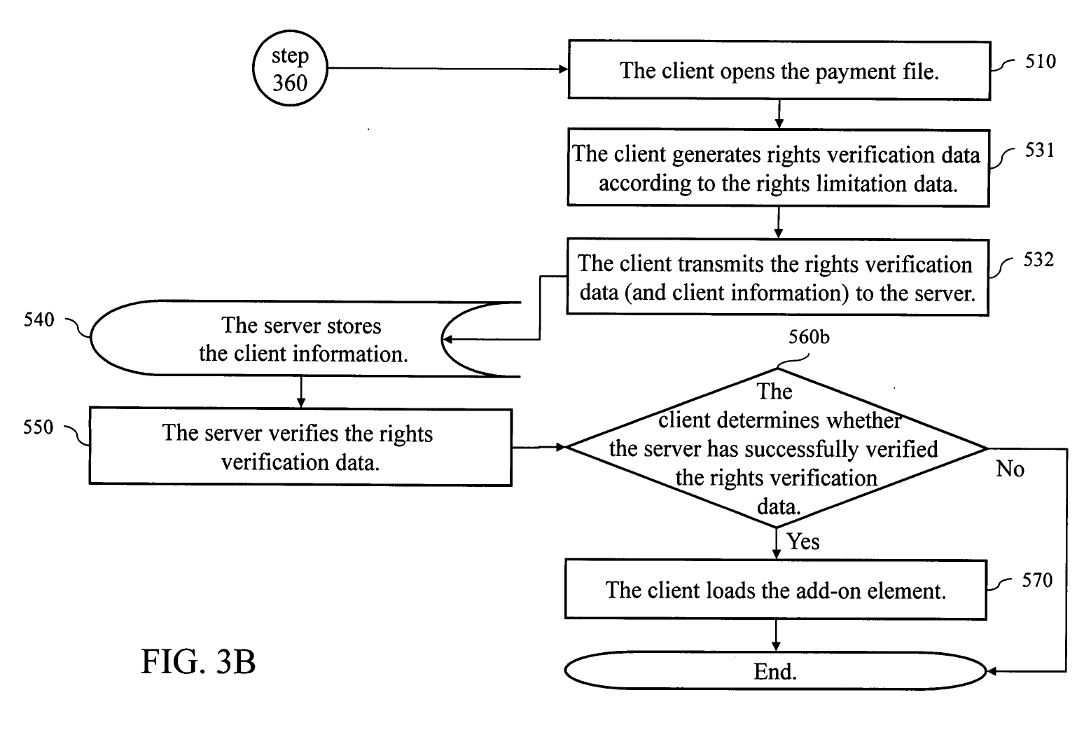

In the following, a first embodiment is employed to explain the disclosed system and method. Please refer to FIG. 3A for the flowchart of the disclosed method.

In this embodiment, the main program is translation software using the invention. The add-on is a plug-in program of human voices. Moreover, the plug-in program of human voices may further contain extension data of voices. In this case, the add-on element is a combination of the plug-in program and the extension data.

After the third party client 400 uploads the plug-in program of human voices (add-on element) to the server 100, the first storage module 110 of the server 100 stores the plug-in program of human voices.

After the user executes the translation software on the client 200, the user can opt to add the human voice function by downloading the plug-in program. Suppose the user executes the function of the add-on element provided by the translation software, the second transmitting module 210 in the translation software establishes a connection with the first transmitting module 140 of the server 100.

Afterwards, the user interface provided by the translation software lists all available add-on elements stored in the first storage module 110 of the server 100 for the user to select. The user can first locate the item corresponding to the plug-in program of human voices in the user interface. He then selects the plug-in program of human voices via the input module 220 of the translation software (e.g., clicking he item). The input module 220 thus generates a first selection signal corresponding to providing the plug-in program of human voices. Afterwards, the user interface displays a message for the user to select his payment method. Suppose there are “pay-per-use” and “pay-per-time”. After the user selects the “pay-per-time” option via the input module 220, the input module 220 generates a second selection signal corresponding to the “pay-per-time” option. Besides, since the user selects the “pay-per-time” option, the input module 220 may need to ask the user to enter the deadline of using the add-on element, such as six months. The invention is not limited to this example.

After the user selects the add-on element and the payment method through the user interface provided by the translation software via the input module 220 thereof (step 320), the second transmitting module 210 of the translation software sends the first selection signal of selected add-on element and the second selection signal of selected payment method to the server 100.

After the first transmitting module 140 of the server 100 receives the selection signals transmitted from the second transmitting module 210 of the translation software, the rights defining module 120 of the server generates rights limitation data according to the payment method (step 351). For example, the rights defining module 120 determines the user selected payment method is “pay-per-time” according to the second selection signal of “pay-per-time” received by the first transmitting module 140. It further uses the deadline “six months” entered by the user to generate the rights limitation data of six months, or uses a predetermined deadline “one year” to generate the rights limitation data of one year.

After the first transmitting module 140 of the server 100 receives the selection signals transmitted by the second transmitting module 210 of the translation software, the rights setting module 130 of the server 100 learns from the first selection signal that the add-on element selected by the user is a plug-in program of human voices. After the rights defining module 120 of the server 100 generates the rights limitation data according to the payment method (step 351), the rights setting module 130 of the server 100 employs the DRM technique to encrypt the rights limitation data generated by the rights defining module 120 and writes it into the add-on element selected by the user, i.e., the plug-in program of human voices, finally rendering a payment file (step 352). Afterwards, the first transmitting module 110 of the server 100 returns the payment file generated by the rights setting module 130 back to the client 200 (step 360).

If the server 100 also has a statistics module 180, then the first transmitting module 140 of the server 100 usually stores the client information, the payment method and the download time of the client 200 that executes the translation software after the second transmitting module 210 of the translation software sends out the selection signals (step 340). However, the invention is not limited to this example. For example, the first storage module 110 can store the client information, the payment method and the download time (step 340) after the first transmitting module 110 sends the payment file back to the client 200 (step 360).

After the second transmitting module 210 of the translation software running at the client 200 receives the payment file transmitted by the first transmitting module 110 on the server 100, the translation software stores the payment file at a specific location on the client 200. This completes the download of the payment file. For example, the translation software can store the payment file under the directory of the translation software on the client 200. But the invention does not impose any restriction on this.

After the user downloads the add-on element (steps 320 to 360), the translation software always searches whether there is an add-on element whether the user continues using the translation software to look for explanations of words immediately after the download or reopens the translation software later on. Since the user has downloaded the payment file containing the plug-in program of human voices, the translation software searches at least the previous downloaded payment files. Afterwards, the add-on element loading module 250 of the translation software opens the payment file (step 510) and checks whether the payment file needs DRM from the rights limitation data therein. Thus, the add-on element loading module 250 verifies the rights limitation data in the payment file (step 520).

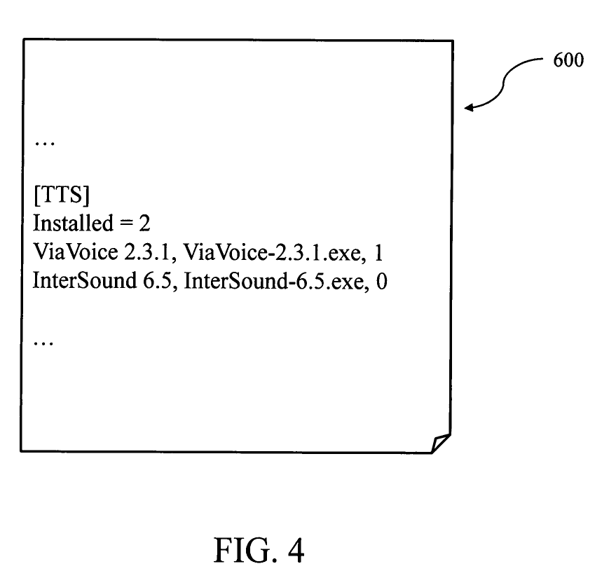

When the add-on element loading module 250 of the translation software searches for the payment files, it is done according to the configuration file 600 shown in FIG. 4. From the parameter “Installed=2” in the item “TTS” that represents human voices in the configuration file 600, the add-on element loading module 250 determines that there are two plug-in programs having the function of human voices. Since only one of them needs to be loaded, the add-on element loading module 250 loads the plug-in program according to some setting on the translation software, usually a predetermined one or a user defined one. It loads the plug-in program of the program name recorded in the configuration file 600. For example, the add-on element loading module 250 selects the first plug-in program, and reads the program name as “ViaVoice-2.3.1.exe” from the record “Via Voice 2.3.1, ViaVoice-2.3.1.exe, 1” of the configuration file 600.

If the contents of the rights limitation data allow the add-on element loading module 250 to directly use the DRM technique to verify the rights limitation data, the add-on element loading module 250 directly verifies the rights limitation data. After the add-on element loading module 250 of the translation software successfully verifies the rights limitation data (step 560a), the add-on element loading module 250 reads and loads the plug-in program from the payment file (step 570) so that the translation software can execute the plug-in program.

If the contents of the rights limitation data need to be verified at the server 100, then the add-on element loading module 250 of the translation software follows the procedure shown in FIG. 3B. Using the DRM technique, after the rights limitation data produces the rights verification data (step 531), the second transmitting module 210 of the translation software sends the rights verification data to the server 100 (step 532) for the server 100 to verify. In particular if the server 100 includes the statistics module 180, then the second transmitting module 210 may also sends the client information to the server 100 along with the rights verification data (step 532).

After the first transmitting module 140 of the server 100 receives the rights verification data transmitted from the second transmitting module 210, the first transmitting module 110 of the server 100 also stores the client information sent along with the rights verification data by the second transmitting module 210 of the client 200, provided the server 100 has the statistics module 180 (step 540). But the invention is not limited to this example.

After the first transmitting module 140 of the server 100 receives the rights verification data, the rights verifying module 150 of the server 100 verifies the rights verification data received by the first transmitting module 140 (step 550). The rights verifying module 150 generates a verification result after verifying the rights verification data. The first transmitting module 140 sends the verification result produced by the rights verifying module 150 back to the client 200. Suppose in this embodiment the rights verifying module 150 successfully verifies the rights verification data. The rights verifying module 150 generates a verification result with the message of “verification succeeded”.

After the second transmitting module 210 of the translation software running on the client 200 receives the verification result, the add-on element loading module 250 of the translation module determines whether the verification result received by the second transmitting module 210 is a successful verification (step 560b). Since the verification result includes the message of “verification succeeded”, the add-on element loading module 250 determines that the payment file containing the plug-in program of human voices passes the verification at the server 100. Therefore, the add-on element loading module 250 reads and loads the plug-in program from the payment file (step 570) so that the translation software can execute the plug-in program.

Suppose the add-on element loading module 250 determines that the payment file containing the plug-in program of human voices does not pass the verification. Since the add-on element loading module 250 finds that there is some other plug-in program of human voices for the translation software, the add-on element loading module 250 opens the payment file containing the plug-in program of human voices “InterSoind-6.5.exe” and generates the rights verification data according to the rights limitation data in the payment file (step 510). The second transmitting module 210 then sends the rights verification data to the server 100 for verification (step 520, step 550). When the add-on element loading module 250 determines that the plug-in program of human voices passes the verification on the server 100, it loads the plug-in program (step 570). This process continues until all the plug-in programs of human voices for the translation software fail the verification.

After the add-on element loading module 250 of the translation software loads the plug-in program of human voices, it provides a tag corresponding to the function of “human voice”. When the explanation data of a word are displayed, there is an additional button in the display area. Suppose the user uses the translation software to look up the word “demo”. To hear the pronunciation of the word “demo”, the user clicks the button in the display area of the explanation data of the word “demo” via the input module 220 of the translation software. In this case, the translation software executes the plug-in program of human voices to generate the pronunciation signal of the word “demo”. It is then played at the client 200 for the user.

In the following, a second embodiment is used to explain the disclosed system and method. Please refer to FIG. 3A for a flowchart of the disclosed method of downloading add-on elements to extend software functions. This embodiment assumes that the client 200 has a computer and a translation device running the invention (i.e., the client 200 is divided into a computer and a translation device). The add-on element is a Chinese-English dictionary database (extension data).

First, the user uses the computer to connect to the first transmitting module 140 of the server 100. He then selects the add-on element “Chinese-English dictionary database” and the payment method “pay-per-use” in the user interface provided by the server 100 via the computer browser (step 320).

After the computer sends the selection signals generated according to the add-on element “Chinese-English dictionary database” and the payment method “pay-per-use” entered by the user via the input module 220, the rights defining module 120 of the server 100 generates the rights limitation data corresponding to the selected payment method “pay-per-use” (step 351). The rights setting module 130 of the server 100 also uses the DRM technique to encrypt the rights limitation data produced by the rights defining module 120 and writes them into the user selected add-on element “Chinese-English dictionary database”, thereby generating the payment file (step 352).

Afterwards, the first transmitting module 110 of the server 100 sends the payment file generated by the rights setting module 130 back to the computer (step 360). The user stores the payment file in a specific location in the computer. Afterwards, the user can copy the payment file in the computer to a specific location in the second storage module 240 of the disclosed translation software, e.g. “\database”. However, the invention does not impose any restriction on this.

After the user turns on the translation device, the add-on element loading module 250 thereon goes to “\database” to search for all dictionary databases. When the payment file “Chinese-English dictionary database” is found, it is opened first (step 510). After determining that the payment file contains the rights limitation data, the add-on element loading module 250 directly verifies the rights limitation data (step 520) according to the contents thereof. Alternatively, the second transmitting module 210 on the translation device connects to the first transmitting module 140 on the server via a wired or wireless network. The rights verification data generated by the add-on element loading module 250 are sent to the server 100 for verification (step 531, step 532). After the first transmitting module 140 of the server 100 receives the rights verification data sent from the second transmitting module 240 of the translation device, the rights verifying module 150 of the server 100 verifies the rights verification data received by the first transmitting module 140 (step 550). Suppose in this embodiment the rights verifying module 150 successfully verifies the rights verification data, it generates a verification result with the message of “verification succeeded”, which is then sent by the first transmitting module 140 to the second transmitting module 210 on the translation device.

Afterwards, if the add-on element loading module 250 on the translation device successfully verifies the rights verification data (step 560a) or determines that the verification result received by the second transmitting module 210 contains the message of “verification succeeded” (step 560b), the add-on element loading module 250 reads and loads “Chinese-English dictionary database” from the payment file (step 570). The translation software can thus use “Chinese-English dictionary database” to provide the explanation data between Chinese and English words.

If after loading “Chinese-English dictionary database” by the add-on element loading module 250 on the translation device (step 570), some other version of “Chinese-English dictionary database” is also required to be loaded, the add-on element loading module 250 can simultaneously load different versions of “Chinese-English dictionary databases”. The translation device can thus search for explanation data between Chinese and English words from different “Chinese-English dictionary databases”. The results are all displayed to the user. The user can set to release the loaded “Chinese-English dictionary database” and load some other version of “Chinese-English dictionary database”. He can also set to use the currently loaded “Chinese-English dictionary database” instead of loading another version of “Chinese-English dictionary database”.

In summary, the invention differ from the prior art in that the server 100 generates the payment file containing the add-on element selected by the client 200 and sends it to the client 200. After the client 200 successfully verifies the rights limitation data in the payment file, it loads the add-on element. This technique can solve the problem in the prior art that the application software cannot be customized according to user's needs. This further achieves the goal of incorporating programs and data provided by a third party company.

In fact, the statistics module 180 of the server 100 can gather the client information, the user selected payment method and the download time for downloading an add-on element, as well as the client information and time of using the add-on element at any time. For example, in the first embodiment, on the first day of each month the statistics module 180 can count the number of times a plug-in program of human voices is downloaded in the previous month and the number of times for different payment methods. Once the corresponding spreadsheet is generated, it is transmitted via the first transmitting module 140 to the third-party client 400 that uploads the plug-in program of human voices to the server 100. The developer thereof can thus charge the translation software developer accordingly. IN the second embodiment, the statistics module 180 counts the number of times the Chinese-English dictionary database is used in the previous month. It also generates a spreadsheet and sends it to the Chinese-English dictionary database developer.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of downloading an add-on element to extend software functions, comprising the steps of:
connecting a client to a server;
selecting an add-on element and a payment method on the server by the client;
generating rights limitation data according to the payment method by the server;
adding the rights limitation data to the add-on element to generate a payment file by the server;
transmitting the payment file from the server to the client;
opening the payment file at the client;
verifying the rights limitation data at the client; and
loading the add-on element after the client successfully verifies the rights limitation data.

2. The method of claim 1, wherein the step of selecting an add-on element and a payment method on the server by the client further includes the step of recording client information, payment method and download time of the payment file by the server.

3. The method of claim 1, wherein the step of verifying the rights limitation data at the client generates rights verification data by the client according to the rights limitation data, transmits the rights verification data to the server for verification, and returns a verification result from the server.

4. The method of claim 1, wherein the step of verifying the rights limitation data at the client further includes the step of transmitting client information to the server for storage.

5. The method of claim 1, wherein the step of loading the add-on element is for the client to execute or read the add-on element.

6. The method of claim 1, wherein the step of opening the payment file at the client further includes the steps of selecting the payment file from a plurality of recorded payment files by the client.

7. A system of downloading an add-on element to extend software functions, comprising:
a server, which includes:
a first storage module for storing at least one add-on element;
a rights defining module for generating rights limitation data according to a payment method;
a rights setting module for writing the rights limitation data into the add-on element to generate a payment file; and
a first transmitting module for transmitting the payment file; and
a client, which includes:
a second transmitting module for connecting to the server and downloading the payment file;
an input module for selecting the add-on element and the payment method at the server via the second transmitting module; and
an add-on element loading module for verifying the rights limitation data after opening the payment file and loading the add-on element after successfully verifying the rights limitation data.

8. The system of claim 7, wherein the add-on element is a plug-in program, extension data, or the combination of plug-in program and extension data.

9. The system of claim 7, wherein the server further includes a rights verifying module for verifying the rights verification data generated by the add-on element loading module according to the rights limitation data and transmitted by the second transmitting module to the first transmitting module, producing a verifying result, and transmitting the verifying result from the first transmitting module to the second transmitting module, so that the add-on element loading module determines whether the rights limitation data are successfully verified according to the verification result.

10. The system of claim 7, wherein the server further includes a statistics module for gathering client information, payment method, number of download times and/or download time of the payment file.

11. The system of claim 7, wherein the add-on element loading module selects to open one payment file from a plurality of payment files stored on the client.

12. A system of downloading an add-on element to extend software functions running on a client connected to a server, the system comprising:
a transmitting module for connecting to the server;
an input module for selecting an add-on element and a payment method on the server via the transmitting module and downloading a payment file via the transmitting module, the payment file containing the add-on element and rights limitation data corresponding to the payment method; and
an add-on element loading module for verifying the rights limitation data after opening the payment file and loading the add-on element after successfully verifying the rights limitation data.

13. The system of claim 12, wherein the add-on element is a plug-in program, extension data, or the combination of plug-in program and extension data.

14. The system of claim 12, wherein the add-on element loading module transmits rights verification data generated according to the rights limitation data to the server via the transmitting module for verification, and the transmitting module receives a verification result generated by the server to determine whether the rights limitation data are successfully verified.

15. The system of claim 12, wherein the add-on element loading module selects to open one payment file from a plurality of payment files stored on the client.
